(19) United States
(12) Patent Application Publication
(10) Pub. No.: US 2007/0220614 A1
(43) Pub. Date: Sep. 20, 2007

(54) DISTRIBUTED ACCESS TO VALUABLE AND SENSITIVE DOCUMENTS AND DATA

(76) Inventors: Jason Ellis, Oceanside, CA (US); Debora Mason, Vista, CA (US)

Correspondence Address: DUANE MORRIS, LLP;IP DEPARTMENT, 30 SOUTH 17TH STREET, PHILADELPHIA, PA, 19103-4196, US

(21) Appl. No.: 11/686,056

(22) Filed: Mar. 14, 2007

Related U.S. Application Data
(60) Provisional application No. 60/782,614, filed on Mar. 14, 2006.

(51) Int. Cl. H04L 9/32

(52) U.S. Cl. 726/27

(57) ABSTRACT

A method for providing access to documents and data files that are inherently valuable, and also documents that contain sensitive information, is configured with robust user identification and document control capabilities and facilitates document submission by, for or on behalf of a user who perhaps is the subject of the document. The document is processed, optionally character recognized and steganographically marked, and is stored in a fixed format together with descriptive identifiers and database indexing values to facilitate control and searching. The level of security encourages users to entrust documents to storage and the system is programmed to control disclosure of documents (or parts of them) according to the user's dictates. Correspondingly strict user identification and document controls apply to those who log on for purposes of document review or serve as authenticators. The result is a virtual safe depository for documents that enables documents to be reviewed when necessary with reduced risk of misuse, for example by inadvertent disclosure to identity thieves and others.

### CROSS REFERENCE TO RELATED APPLICATION

This application claims the priority of U.S. Provisional Patent Application Ser. No. 60/782,614, filed Mar. 14, 2006.

### BACKGROUND

1. Field of the Invention

The invention relates to the field of secure management of documents and data, using a distributed network coupled to a data store. Input and output programs with user interfaces are operated using programmed processors to facilitate user identification, establishment of a level of authorization, collection and storage of copies of valued documents or data presented by users. Processes permit use of the stored copies as a standard of comparison against materials that later users present for authentication as true copies, or for download of copies, according to levels of access that are predetermined by the user according to the value and sensitivity of the information.

2. Prior Art

Various types of documents are important because they embody personal identification or represent or embody legal rights such as ownership of property or contractual rights, authorizations, licenses, and other matters. A traditional technique for guarding important documents is to rely on the existence and protective custody of original documents. Examples of one sort of “original” documents include notarized documents and documents under seal, documents that are originally signed by an issuing officer, documents bearing indicia of an institution, documents recorded on sheepskin and the like. Another and also important sort of original document is a document that is directed specifically to a particular subject, such as a bank statement, credit card statement or even a bill from a tax agency or utility. These statements often embody identifying information that is associated with the subject to the extent that loss of the document or loss of exclusive custody of the document presents a risk of fraud or identity theft.

In the case of important original documents such as birth certificates, passports, licenses and diplomas and the like, the original character of the document is an aspect that causes the document to be accorded credence. The document has inherent value. It must be protected against loss or damage. At the same time the document must be conveniently available for presentation when needed to vouch for the bearer's identity or authority. This generally requires that the valuable original document be stored where it an be found, transported when needed for review or examination, and loaned into the custody of the reviewer while it is examined. These steps carry uncertainty and risk. On the other hand, absent misappropriation, the fact that a bearer has custody of an original document carries some credence that the bearer is the person to whom the document refers or has obtained the document from that person.

In the case of documents (including not only paper documents, but also information and data) the document (etc.) is important because the information found in the documents is sensitive, the value is embodied by the information contained and a loss can occur if the information becomes known to an unauthorized or dishonest reviewer. However, documents bearing sensitive information are also valuable, and need to be kept conveniently available for reference in the regular course of business by their subject.

Aspects of the present disclosure are applicable to these and other sorts of documents and data, whether inherently valuable or tending to reveal valuable information. Depending on the relationship of the document reviewer to the subject of the document, it may be sufficient if an assuredly authentic copy of either sort of document is available. An advantage of providing certified copies of important documents is that the valuable original can remain locked away and the content of the original can be discerned from the certified copy. However, in the case of documents tending to reveal valuable information, access to the copy tends to reveal the valuable information with the same effect as if the original document was revealed. Therefore, the production of copies and access to copies are to be controlled.

In connection with document management, it is known to provide document databases including profile information that can establish a security status for each document. Among other things, access to documents can be limited to certain users or classes of users. Documents can be designated as read only. Security information, transaction logging, messaging to report transfer, document descriptions and other information can populate database fields, forming a document profile for searching and/or selective document handling. The full text content of documents can be indexed to enable searching. Examples are disclosed, for example, in U.S. Pat. Nos. 6,314,425; 5,813,009. (The disclosures of these and each of the other patents mentioned in this summary of the prior art are hereby incorporated by reference, in their entireties.)

Insofar as such a database encompasses documents, the documents can be data files (e.g., ASCII encoded alphanumeric data) or images of the documents as they are printed or might be printed from the data. The images can be in spatially sampled pixel bitmap format or in a compressed image data form. The data need not be limited to visual data but can comprise sampled audio messages (U.S. Pat. No. 6,857,074), encrypted data (U.S. Pat. No. 6,976,165), logged emails (U.S. Pat. No. 6,597,688), etc.

The database can be made available over a wide area network, including over the Internet. Examples are disclosed in U.S. Pat. Nos. 6,584,466; 6,289,460. For a facility that has a particularly heavy throughput of document scanning and processing, dedicated scanning and data entry stations are possible (e.g., U.S. Pat. No. 4,082,945).

For the most part, such databases are tailored for collaboration and facilitate the ability of all users to generate documents and later to find and access their documents and those of other authors, based on document content or the content of associated database fields. The functions of the such a system are a combination of word processing and library functions. It is possible for a user who is the owner of a document to impose security. The available security shields the secured document from other users. There is no real facility for enabling varying degrees of access to a read-only valued original, or secure passing of files containing important data from one entity to another after establishing authenticity, while organizing access limited to a designated subject and the integrity of the original content.

In a different environment that is known in the art, access to documents can be regulated so as to facilitate charging persons for access to the documents. This type of information network is like a digital library, and an example is disclosed in U.S. Pat. No. 5,832,499. Examples include technical libraries, legal reporters and the like. The object of these systems is to facilitate searching while accounting for charges. In order to realize such a system, it is typically necessary to impose password access (for billing) and to regulate the extent of information transferred (e.g., abstracts or full text). The database operator typically endeavors to upload accurate documents in the interest of quality. There is substantially no incentive to alter the documents or for dishonest persons to submit faked or fraudulent documents, perhaps under alias usernames, in the hope of defrauding others to the dishonest person's advantage.

Some original documents are particularly critical. Systems for ensuring the safety of documents and data files have been proposed. Some such systems are considered as secure as a trusted personal courier (U.S. Pat. No. 6,185,683). However, extensive data protection carries overhead that is too much complication in a typical document management system.

Document managers are configured and operated with different objects as compared to a system for establishing the authenticity of an important original document, storing and guarding a copy of the important original document in a manner that carries assurances upon which an authorized reviewing party can rely, and managing access to the document in a way that prevents misuse. It would be advantageous if valuable original documents and data that represent identification or asset value could be received, assured of accuracy and authorization, and made available under controlled limited access in a way that reduces risks to the submitter of identity theft and loss of confidential information, and risk of monetary loss or victimization due to fraud, on persons who may be induced to rely on the documents and data as accurate and authorized.

One line of protection is the assurance of the identity of the submitting party and the reviewing authority. As discussed herein, it is also possible to involve other parties, such as the issuer of a diploma or license or the like, as a vouching party, although the issuer might or might not be the submitter and in any event is not the subject to whom the document was issued. Although the submitted information might be false, the extent of available identification of the submitter can be taken into account. The submitter is thereby made accountable for alterations, or if not fully identified, reviewers can withhold their reliance as appropriate.

The possibility that a copy has been altered can be addressed by providing an ability to compare the copy against the original. This again requires access to the original, and risk to the original. An alternative might be to provide plural sources of certified copies whereby an ostensible original can be compared to a more or less trusted copy. Although this technique protects the original, there is a danger that the copy does not match the original either. There is also a lack of assurance if various copies exist, as to whether the bearer is the person to whom the document refers.

Furthermore, whether a reviewer is considering an original document or other information carrier, or is considering a copy that is certified to be accurate, there is always a risk that the bearer is not the person to whom the document refers. The document could have been misappropriated by a person who seeks to take improper advantage of the reviewer's reliance on the document.

Various more or less technologically sophisticated techniques are known in the art for guarding original documents. Various more or less sophisticated techniques can be used when making copies of originals to distinguish between copies and to provide some indication when alterations have been made.

In the modern field of digital imaging, it is possible to generate a file integrity hash associated with a data file such as a digitized image file or other collection of data values. A known algorithm having an output value that is highly variable with content is applied to data file content to produce a hash file that is stored. If one starts with an authentic and trusted digital image file that accurately represents the original, then when presented with an ostensible copy of the digital image, the same algorithm can be applied again later and should generate an identical hash file. If the new hash file is identical to the stored file, the copy is a true copy. The comparison of hash files can be made without openly exposing the data content. Thus, it is possible to separately store the hash file as a means to enable a determination whether as subsequent copy has been altered.

Conversely, it may be desirable to determine whether a copy was generated from a known original, even if the copy has indeed been altered in certain ways, such as enlargement/reduction, change of image resolution, processing for image quality (brightness, contrast, color balance, etc.). For this purpose, digital watermarks can be unobtrusively inserted into data, including image data, in a manner that is detectable notwithstanding digital/analog conversions, enlargement or reduction, compression/decompression and other processes that might obscure other types of security markings. Without knowledge of the nature of the watermark and how it was encoded, it can be difficult to determine whether such a marking is present.

By use of a battery of such techniques, including digital signatures, log-on passwords, public and private keys, symmetric and asymmetric encryption, hash algorithms, bidirectional communications for inquiry and acknowledgement message exchange, and combinations of all these techniques, to establish with a degree of certainty that a party who purports to be a particular person or purports to be the authorized source of a document or an identified actor in a given transaction, is in fact that person. Similarly and in addition to identity verification, it is possible to provide access to guarded original documents and files, by which one can assess whether the documents or files appear to be bona fide and to review their contents in an effort to assess whether a person presenting documents or data are who and what they are purported to be.

The more sophisticated and highest security identity and document or data verification techniques and capabilities are generally not available to members of the public as a practical matter. Furthermore, for documents such as banking statements and credit card bills, alteration of the data contents is not a risk. Generally, members of the public are required to maintain original identity documents, licenses, legal documents and the like, and to be willing and able to present the original documents when requested by persons or companies or governmental agencies seeking to verify the identities of such members of the public. Members of the public are inclined to accept banking statements and bills by mail, to file them temporarily and to find and refer to them in connection with regular business activities.

An original document such as a passport, birth certificate or deed for real property or the like might be required to be presented to establish identity or other data in connection with a transaction. The risk is on a reviewer who relies on the document. An examination may reveal that the document appears to be bona fide and unaltered, but persons who might rely on such documents also need a way to assess whether the bearer is the person named and/or whether the bearer is authorized to proceed with the transaction they request. As a result, there are several levels of association and security that need to be considered and definitively passed upon, when making security decision. Thus, when presented with ostensible documents, one might examine whether the documents appear to be valid or counterfeit, perhaps requiring an expert examiner. There is a potential that documents might have been altered, even if the documents comprise correct materials, official seals or other markers. There is a potential that the documents are accurate but the that bearer is not the person named or is not authorized to employ the documents in the manner used. Without any system for checking with the person who is the subject or custodian of the document or data, with certainty of that person's identity, one cannot readily establish authorization. Without a system for checking with the issuer of the document or data, again with certainty of the issuer's identity, one cannot be certain of the accuracy of the content.

For documents containing sensitive information, a primary risk is loss of confidentiality resulting in the sensitive information becoming known to unintended reviewers. This is not only a problem of custody, because if an unscrupulous person fraudulently identifies himself to a custodian of information, the information may be revealed due to mistaken identification of the reviewer requesting the information. It would be advantageous if an automated networked document management system could be tailored to handle a range of transactions, involving different sorts of documents, different sorts of information and different possible relationships between parties that in different instances have different roles. For example a system is needed that is not only capable but is optimized for the needs of parties in different roles, such as the subject of information, the submitter or custodian supplying a document, a party needing to review the information, and perhaps a party that would vouch for its accuracy and/or the authority of one or more of the other parties.

There are any number of types transactions that have some degree of security risk. In order to carry on commerce and otherwise support such transactions, there are various identity and status defining documents that may be available to the actors. A number of such documents are typically carried on the person. Some are kept in files that are to some extent guarded. Documents that represent value are sometimes stored in fireproof lockboxes an in off-premises safe deposit boxes. The more valuable of these documents are often the most protected and although that makes them relatively authoritative, they are also quite inaccessible on short notice.

Such documents and the information they carry or to which they provide access encompass a range of document types having different degrees of popular respect. A nonlimiting list of identity document types includes birth certificates, passports, marriage certificates, military discharge records, social security cards, picture ID cards, fingerprint records, and various membership cards, numbers and serial number indicia. Some documents that bridge on identity documents may also carry evidence of qualifications and permissions, such as diplomas, educational transcripts, professional licenses, drivers' licenses and the like. Some documents may carry value or be associated with accounts such as negotiable stock shares and bonds, credit and debit cards for banks, phone account cards, credit reports, financial statements. At times, one is required to supplement relatively permanent documents and evidence with verification of a current address, such as presenting current tax or utility bills that show an address. Other such documents with information that is sensitive likewise can include bank account statements, credit card bills and statements, tax returns, insurance records, medical reports, prescription records, payment vouchers, etc.

It may be more crucial to have the ability to prove and establish the integrity of some of these categories of documents as compared to others. It may also be more important in terms of risk avoidance to keep some information secret (e.g., credit card and social security numbers) for limiting exposure to identity theft, whereas other information may be sensitive but not as subject to fraudulent use.

It would certainly facilitate many types of transactions if access to identity and status defining documents could be provided safely, dependably, quickly and inexpensively for various types of documents and data, while retaining the ability to limit access to sensitive confidential information and at the same time to provide sufficient access to enable verification of true copies and their content, with appropriate accountability with respect to those who place documents into a repository, those who obtain copies and those who seek and are given access to the repository or at least to test for an association of an isolated data value with a person for verification purposes. It would enhance security and confidentiality if the same or a similar system could be used by the subject of confidential documents and data, to ensure that information can be relied upon as authentic (as opposed to a phishing attempt), easily located in an organized way, and protected from disclosure to unscrupulous users.

Enlarging capabilities for access to documents bearing identifying data might be expected to increase the danger of unauthorized use and misappropriation of identity information, unwanted disclosure of confidential information, presentation of altered documents in support of fraudulent transactions, damage to the reputation of honest persons whose information is accessed and exploited, and similar risks. What is needed is a definitive repository for documents and data, where such documents are submitted for exchange only upon authorization, for example between an owner or originator and a subject to which the document or data refers, where the owner can control access using passwords, encryption, digital certificates and bidirectional messaging as desired, and wherein the owner can obtain or allow others to obtain certain services involving access or verification.

### SUMMARY

The present invention relates to an openly accessible network and data processing system configured for secure and verifiable reception, storage and handling of information that represents value to a user or subject, and typically carries value or represents a risk to a party with whom the user chooses intentionally to share all or part of the information. Such information advantageously comprises document images but could also comprise data per se. The information contained or stored in this manner is generally described herein as protected information content. However, such protected information content could also comprise a key or code that enables access to other content that is guarded from access without the key or code.

According to the disclosed system, the identity and authority of any party who submits information content, attempts to vouch for content, or seeks access to content, is determined using indicia associated uniquely with the party. Information collected from the party can be compared to identifying information from a secure database to determine identity and/or authorization if such identifying information can be found. If not found, access is denied. Alternatively, the collected information can be stored and access limited. The submitting party might be the owner who is the subject of a document containing information content. A submitting party might be a trusted source, such as a government such as the issuer of a license, diploma or the like, etc.

The information content, such as copies of original documents and certified images of original documents, is submitted, encoded and stored in an access-controlled data store. The content is stored with cross references to the manner of submission and the identity and bona fides of the submitter. Insofar as the content is associated with relatively assured identity information, the content is deemed more trustworthy than other content that may be less assured. Within the system, the received copy (which might be more authenticated or less authenticated) is stored in a manner protected from alteration. For example, the copy can be stored redundantly, supported by encryption hashes to facilitate later detection of alterations in any subsequent copies, etc.

Access to the authentic copy is controlled according to the authorizations that may be granted and sought. The system can enable a range of authorizations by programmed processes controlled by inputs from the subject, the submitter, a party vouching for the submission, the requester, a party vouching for the requester, a third party authentication or comparison service, etc. If copies are provided, they can be marked for tracing purposes. The information (such as digital image data comprising a copy) might be designated to be retained in secret, and used only for comparison against newly submitted copies for confirming whether or not a newly submitted copy is a true copy of the stored one. Alternatively, the information might be made available over the system generally, or to the submitter alone, or only to entities having a prescribed level of authorization from the submitter, or only by command of a trusted authority, etc. These and other options can be governed by a system of differing levels of authorization to qualify for differing levels of access, carried out by the system programming.

According to one aspect of the invention, these and other capabilities are provided as a service to customers over a widely available data processing system that resembles a financial services terminal network. However the terminals for the system employ document scanners and user identification facilities such as keypads, cameras, biometric readers and the like. Alternatively or in addition, the service can comprise staffed branch offices or mobile offices. In any case, persons are able to submit documents for the generation and safekeeping of dependably accurate copies. By providing an infrastructure for production, secure maintenance and limited access to dependably accurate and substantially irrefutable copies of original documents, transactions that depend on the documents are facilitated, while the originals are protected from alteration or misuse.

An object of the invention is to establish a service that is made generally and widely available to users over a network of terminals coupled to a secure communications network and data processing system, similar to and optionally comprised in an automatic teller machine network useful for financial and other secure transactions. However, the invention handles certain limited transactions concerning handling copies of information and/or document images (information content).

These transactions are related in part to security in obtaining accurate and reliable information content from a submitter, and in part to determining accurately and reliably the identity and authorization of the submitter to proceed. One or both of these aspects are checked as a part of the content submission process. Optionally, the content of the information or the identification presented by the submitter (or both) can be subject to cross checking against records maintained by a trusted authority such as a government entity or license issuing agency.

Steps are thus taken to establish the identity and authority of the submitter of the information content. Moreover, the information content that is submitted (e.g., an original identification document such as a birth certificate) is protected in a manner that can be tested and relied upon when a copy of the information content is to be presented. The information content, such as original documents and certified images of original documents, are protected more effectively by the secure copying and certification techniques of the invention, that it would be possible for a submitter to protect the original documents using conventional document protection techniques such as via fireproof boxes, guarded safe deposit boxes and similar techniques.

A number of techniques are provided by which submitted documents and information content are protected from alteration, and/or by which an entity that accesses the information later can detect if alteration has occurred since the documents and content were first submitted.

The submitter or subscriber can selectively avail himself or herself of different levels of security. The reviewing entity that access the information likewise can avail itself of different levels of security up to the levels under which the submitter's identity was determined and by which the documents or information were collected.

Under the auspices of the network and data processing system, the submitter can be assured that the content is safe from loss or alteration. Those to whom the content is made available can be assured, due to the involvement of the system in collecting and producing the content, that the content indeed came from a submitter whose identity was established in a prescribed way, and has not been altered.

Preferably the manner of establishing the submitter's identity is reported if not made subject to independent verification. Third party authorities such as government entities that grant licenses and certifications can optionally be involved to vouch for copies or to provide original copies to the network at the request of the submitter.

The network and data processing system as described are operated as a service for subscribers, and also serve the interest of persons who need to be privy to information or images, at the subscriber's behest, with a least a predetermined level of assurance of the trustworthiness of the information or images.

According to one aspect, these steps are supported using a data processing network coupled to input and output devices, and programmed in a manner to permit reliance on at least certain aspects of documents and other data, such as the fact that they are unaltered copies of materials that were uploaded at a particular time and place by an entity especially providing a secure but accessible network repository, user interface and associated processes for members of the public and others to establish records of important documents and data that are fixed in content. Provisions are included for encoding, for encrypting and marking content, generating security hashes, etc. Provisions are included to determine the identity and authority of the submitter and his/her association with the documents or data, including optional verification of the accuracy of the content by an authoritative entity or agency.

According to another aspect, the repository of content is configured for wide access over a network accessible communication and data processing system, while at the same time having provisions to assure authorization and authenticity. Users can establish their bona fides and memorialize copies of important documents or information that may later be presented to others, under the auspices of the disclosed system as being authoritative at least to the extent of such bona fides, and to a level of access that is predetermined by the submitter or subject. In this way, the system provides a technique to vouch for copies for documents or items of information that might be relied upon by a contracting partner when entering a transaction, or otherwise might be useful to attest to the user's identity or qualifications, to establish references and so forth.

Data records are produced and stored, and processes for accessing the records are configured, to enable true copies of all or redacted parts of documents to be regenerated with a high degree of certainty as to their bona fides, including content accuracy, completeness, authorization of access for view or copying, testing for certain aspects such as association with a certain user or entity, and similar aspects relating to security. These records are made available via network accessible processes that permit verification of documents or files that may be generated for presentation as true copies of the originals.

The ability to generate and store authoritative trusted copies of documents and data, and to produce and/or compare copies of documents and data to trusted reference information for verification (provided the user grants such access), reduces the need to rely on original documents or files. Without the need to access, transport and handle original documents in connection with transactions, there is a reduced risk of loss or alteration of such documents and a consequent greater willingness for others to rely on them when considering a contract, assessing credit, granting access, etc.

It would be advantageous to establish the repository in a manner that supports impartial verification of certain types of documents or data that are particularly sensitive, for example by confirmation from governmental or other entities as to accuracy. The documents and data, or parts thereof, must be released exclusively under control of the owner or subject in a way that provides safety against misappropriation or use in commission of an identity theft. When released under such control, the documents or data advantageously are subject to confidential verification by a trusted authority that need not release all the information in a document or file. Instead, the authority may support limited verification steps such as the capacity to attest to the previous association of one indicia such as a picture or the like, with another indicia such as a name or account number. Assuming that information is to be released, the authority or the repository may be caused to release a copy or data file only under encryption and/or integrity verification procedures and codes that were previously established by the person who is the owner or subject of a given document or data file.

If a trusted repository can be established in such a manner, safe from alteration, limited as to access by unauthorized entities, confidential and accountable, then identity verification, credit investigation and similar security steps can be facilitated, improving the assurance of parties entering into transactions that entail risk to one or another of the parties, and facilitating the conduct of business.

These and other aspects are provided according to the system of the present invention, comprising a data processing network and its associated operations, communications, storage and method steps. In general, the invention includes user authentication aspects, applicable to those who may upload copies, those who may be granted access to copies and those who may certify the copies. An application layer is provided, operable using appropriate communication and input/output devices. A graphical user interface is operated by users for selection and control purposes. The system comprises a secure document delivery system, a preferably-distributed document capture operation, a virtual safe deposit box for storage, and techniques for authentication of documents and copies of documents.

### BRIEF DESCRIPTION OF THE DRAWINGS

There are shown in the drawings certain exemplary embodiments that illustrate aspects of the invention. However, the invention is not limited to the embodiments and instrumentalities disclosed as examples. To assess the scope of the invention, reference should be made to the appended claims. In the drawings,

FIG. 1 is am overview block diagram showing the elements of the inventive system.

FIG. 2 is a block diagram showing the elements of the user authentication processes of the system (note that the particular user might be a submitter, reviewer, subject or other involved entity).

FIG. 3 is a diagram illustrated document and data capture elements according to an exemplary embodiment of the system.

FIG. 4 illustrated document and data delivery elements according another example.

FIG. 5 is a diagram showing a number of aspects that characterize each of the main blocked element illustrated in FIG. 1.

FIG. 6 is a block diagram illustrating elements that can be associated with respective embodiments of user access terminal.

### DETAILED DESCRIPTION

According to the invention disclosed herein, a preferably widely distributed data processing network and associated processes provide for the necessary input/output, communications, storage and programmed transaction to allow individuals, corporations and government agencies a practical and efficient way to deposit, protect in fixed content form, access and exchange documents, data and records. These documents, records or other information and data are processed to enhance their reliability as authentic and are handled in a manner intended to avoid unauthorized release or disclosure. Copies can beauthenticated as to source and content, withdrawn, transferred to another entity, viewed according to one or more permitted levels of access, and similarly used in many of the same ways that the user or subject might protect a valuable original document in a locked file, strongbox or safe deposit box, or might guard a document bearing sensitive information against disclosure, such as document revealing identification and account information.

The invention can be operated over data processing network facilities that are similar to automatic teller machine (ATM) facilities of a financial institution. A network of terminals having input and output means are employed to interface with users who are subjected to password and other security steps. According to the invention and unlike a typical bank network, document scanners are included. Preferably, robust user identification data collection and security techniques and apparatus are provided, such as biometric inputs for confirming user identity. Robust data security processes are used as well, including password techniques, prompt-and-reply communications for answerback from expected communication lines, etc.

According to an advantageous embodiment, the documents and records that are deposited, withdrawn, transferred, viewed and authenticated advantageously are limited to fixed content documents only, often carrying some sort of identification, value or information about a particular person who is the subject. Examples could be inherently valued documents such as a diploma, a deed for land, a government license or the like, which either represent value or may be relied upon by parties who risk loss if the documents are not authentic or their association with the submitter is fraudulent. Other examples are documents that reveal identification information, account numbers, balances and the like, such a bank or credit card statements that if revealed would pose a risk to the owner or subject.

In any case, the value of such documents and information, and the potential risk to others who may rely on them at the behest of someone who claims to be the subject, depend on the original integrity, authenticity, confidentiality and non-refutability of the documents or records. The same issues are presented as to documents that are claimed to be true copies of the original documents or records, or accurate and dependable abstracts of information from the original documents or records.

A non-limiting collection of examples of documents of this type may include signed contacts, birth certificates, passports, medical records, prescriptions, deeds and mortgages, liens, tax returns, diplomas and transcripts, commercial and professional licenses, certificates of inspection, audited financial reports, government-issued documents, statements of account, bills, insurance and medical information, test results, and many others. These documents and records need to be retained safely by individuals, corporations and government agencies for a pre-determined number of years, while maintaining their original integrity.

In general, this disclosure distinguishes among several respective parties involved the use of documents. The parties can be designated to include one or more subjects, namely parties who are interested in a document and possibly but not necessarily are named thereon. A document or data file may have one or more subjects. For example a contract may have at least two subjects who are parties to the contract. A birth certificate might affect the person whose birth is recorded as well as the parents and perhaps even a sibling or other relative in some fact situations. A diploma might have the graduate as subject or in some instances the issuing institution might be the pertinent subject. Depending on the document and the situation, the subject may wish to keep the document or data wholly confidential or to reveal the document or data only under strict control.

The respective parties include the submitter who provides the document or data. The submitter could be the subject, for example in the case of submitting one's own document for safekeeping and/or future ready reference. The submitter may be a party who contracts with the subject or provides a service to the subject. An issuing or vouching entity might engage in a process of submitting documents. For example, a state motor vehicle office might be the submitter of drivers' licenses, the subject of which is each licensed driver. In the case of submission by the subject, the state motor vehicle office might be contracted to vouch for the authenticity and accuracy of the data, including for example, a picture of the licensed driver.

Another pertinent party is a reviewer to whom the document or data is revealed for one purpose or another. In a contractual situation, the reviewer could be the subject of a document submitted by a contracting party, for example where the document is the monthly statement for a customer, submitted for the customer's use by the customer's a bank. A reviewer often relies on the document or data. A reviewer might or might not be interested in the document or data being kept confidential. In the different example of a driver's license as the document, the reviewer might be a bank who is willing to cash a check in reliance on the document as identification. The reviewer needs assurances provided by the system that the offered driver's license or data was validly issued, that the picture on the driver's license has not be altered, and (perhaps by observation) that the picture matches the person attempting to cash the check. The reviewer is often the person who is taking a risk. However, the submitter and subject may also be subjected to risk, for example that information from the reviewed document will be used to damage the subject or the submitter.

An optional party to the list is an authenticator who vouches for all or part of one or more documents or data that are stored in the trusted data repository of the invention. Such an entity might be a submitter of information, a reviewer who verifies information, or an outside service that responds to requests to report on information by comparing all or part of the information to an independently stored repository of pertinent information.

According to the invention, levels of access and authorization are contemplated to protect each of the respective parties, and to allow each party to determine the risk that the party is willing to undertake as a function of the extent of assurances associated with the other parties.

It is sometimes possible and prudent for a party who wishes to rely on a document, to confer with independent public records sources (e.g., a recorder of deeds) or to confer with an entity who may be opposed to the subject in a contractual way (e.g., to verify a statement with a bank issuing a line of credit), but this can be cumbersome and relies on the extent to which records are publicly disclosed and publicly available. In order to protect the subject from fraud, identity theft and the like, it may be preferable to control access to the information or to limit the categories of information that will be provided to inquirers based on the extent and trustworthiness of the identity and representations of a requester. The present invention provides security and controlled access in a manner that enables the establishment of secure and dependable copies and secure control over access and use.

The inventive system can be provided by an institution as a service to users. Alternatively, the system can be a service provided in consideration of a subscription fee for a given time or a transactional fee relating to the number of documents submitted or accessed and the extent to which data processing resources are exploited. Parties that advantageously use or support the system can be individuals, groups, commercial or nonprofit companies, government agencies or the like.

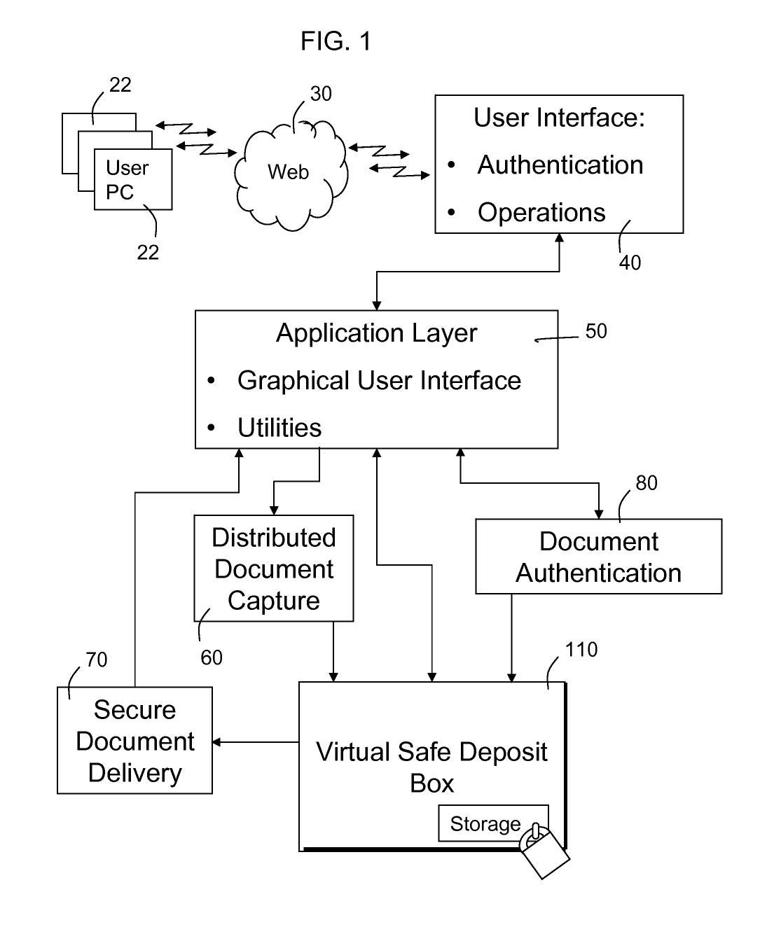

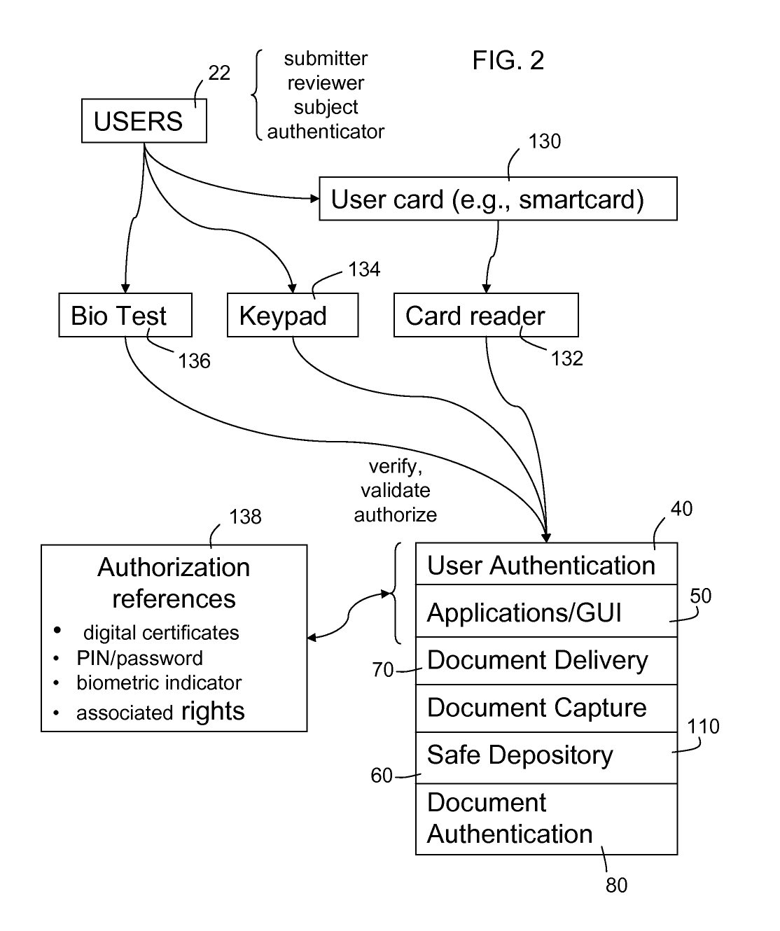

With reference to FIG. 1, the system of the invention can comprise a number of subsystems and/or functional portions that may be embodied in different hardware and software arrangements, grouped together in particular processors or distributed, etc. The basic elements and/or processes as shown in block diagram in FIG. 1 include a user authentication portion 40, an application layer 50 including a graphical user interface and data processing utilities and capabilities. A secure document capture process 60 and secure document delivery process 70 are invoked during transactions with submitters, subjects and reviewers, each of which logs on as a user 22, over a network 30, preferably the public Internet. The documents and associated data reside in a virtual safe depository 110. User authentication aspects are shown in FIG. 2.

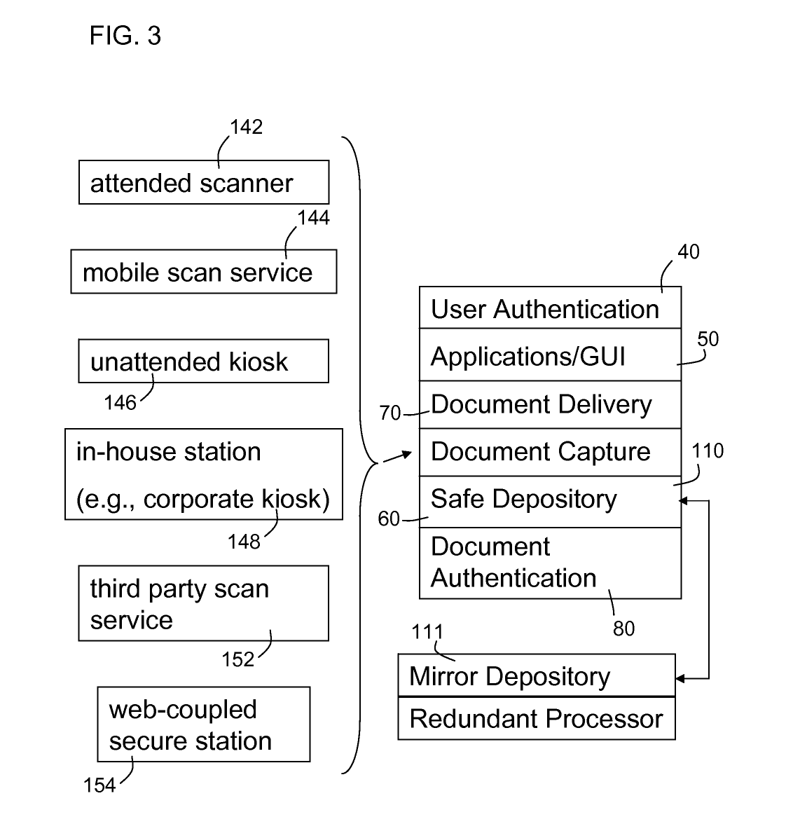

Preferably, users 22 access the system over distributed terminals or stations that comprise document capture elements are provided as a part of the system for collecting the documents and data. The document capture aspects are shown in FIG. 3. The user authentication processes (FIG. 2) are configured to enable document submission from a trusted source and to permit document retrieval and review by a trusted reviewer only. Robust user access log-on and security provisions are provided. Nevertheless, the arrangements preferably are sufficiently convenient to facilitate access in the manner of a digital “on-ramp,” for example providing for conveniences, such as the ability to submit instructions and requests via secure cell phone or PDA signaling techniques.

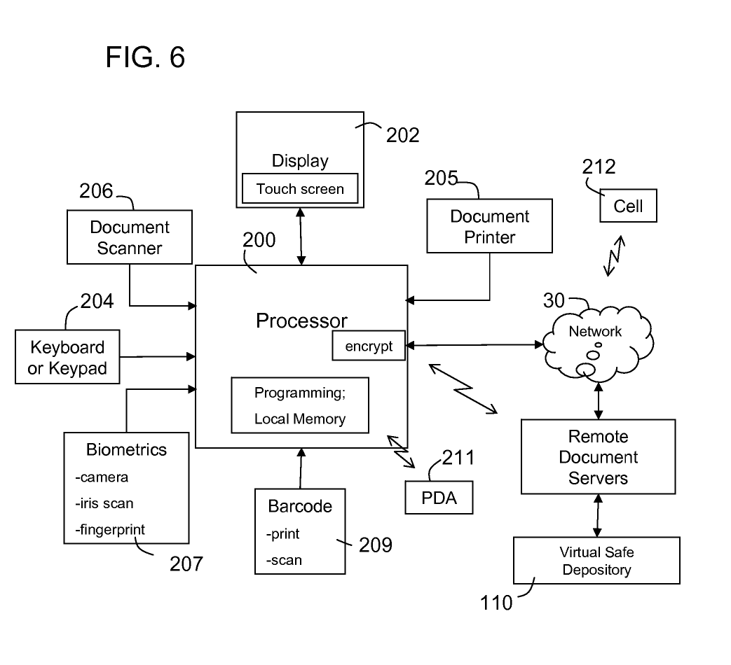

Exemplary aspects of the user authentication system are generally shown in FIG. 2 and discussed in more detail below. The user authentication system comprises input and programmed processes and devices configured to provide a degree of access that permits the submission and authentication of documents and data by submitters, the access to at least part of the data by reviewers, and optionally for later comparison of ostensible copies or versions to the protected originals to trace copies and identify alterations and possibly to narrow down the source of alterations. The users 22 who may individually be a submitter, reviewer, authenticator, comparison source or voucher, etc., can all be served over the same network coupled distributed terminal devices, described with reference to FIGS. 3 and 6. A given user at different times could conceivably be acting as a submitter, reviewer or authenticator. Each user is required to establish the user's identity so that actions taken by the user can be associated in the operation of the system with that identity.

In FIG. 2, users 22 preferably are issued a user card 130 that is loaded into a reader 132. The user preferably enters PIN or password data via a keypad 134. Additional measurements can be collected from a biometric input device 136. The user proceeds according to prompts from the user authentication process 40 of the document server network system. Reference is made by the system to user authorization references 138, which have been stored as a startup process and identify the user for later log-ins.

The credentials for identification of user 22 can be subject to rating. That is, insofar as the user's identity is very securely established (e.g., using robust data input variables and techniques that are difficult to spoof), the dependability of the identification is relatively well assured and this datum can be taken into account for determining the activities that the user will be permitted to conduct. For example, the ability to recite a social security number or a mother's maiden name may provide a low level of assurance. The comparison of an iris scan or fingerprint or similar biometric with previous measurements stored in a trusted identification database (or better yet a combination of several such identity checks) can provide a high level of assurance. Therefore, at least a subset of terminals arranged for user access can have one or more of a keypad, full keyboard, a reader for accepting user cards (such as a magnetic stripe or smartcard), or a biometric data collection unit such as fingerprint reader, iris scanner or other camera device for visual input.

If a user is a new subscriber without stored biometrics and cannot be cross referenced to data in a trusted database, that user can be logged and authorization references established at that time. Such a user may be accorded a lower level of access compared to a user that has an established history and perhaps already maintains a virtual safe deposit in the depository 110. The user's biometrics can be measured initially and again when logging on at a late time, to provide measurement data in a trusted identification database containing authorization references 138.

A responsibility of the authentication function is to verify and validate the identity of each user logging into the system, which together with predetermined rights established by a document submitter define the extent of authorization of the user to review, print or handle documents or data. For this purpose, user profiles are established and managed. These profiles can include passwords, digital signature techniques, digital certificates and encryption keys (symmetric or asymmetric public/private pairs). According to one embodiment, all or a subset of users can subscribe to a user level whereby the users are issued a user Smart Card 130 (also known as an integrated circuit card or chip card) and a PIN code (Personal Identification Number) for entry via keypad 134.

The security aspects including user authentication system 40 also entail the configuration and management of network firewalls, intrusion prevention and monitoring systems as well as protecting the system from all external and internal attacks. The precautions taken might be more or less robust in a given embodiment, but are arranged at least to minimize the probability of a successful attack. The extent of security protect is chosen such that the inconvenience imposed on users is tolerable in view of the value of the documents and data that are accepted for protection according to the invention, and the difficulty imposed on an attacker to overcome security precautions (such as brute force attempts to decode passwords or encryption keys) engenders a greater expense to the attacker than the value the might be realized by fraudulent use of the protected documents and information files.

The input and output between the users and the peripheral devices and/or distributed terminals operated by the user are operated according to an application layer 50, which contains operational software routines and an operational graphical user interface (“GUI”) for interacting with user 22. The application layer 50 and graphical user interface operate to deploy and control other system resources and services. These include accepting and processing user input and user data including the documents and files that are to be managed. The application layer processes submitted documents and files according to the user input selections and according to programmed processes. The applications and user interface 50 present information to the user and prompt and otherwise obtain information from the user to effect system functions. According to programming, the interface with and among the individual subsystems can include a process for proactively monitoring and managing system performance.

The user interface is subject to variation and can be embodied to suit a range of different input/output environments, generally shown in FIG. 3. Preferably, the user enjoys a consistent interface with the system in each of the environments. These different input/output options as shown in FIG. 3 operate functionally as digital on-ramps that route documents and data to and from the virtual depository 110. Various access devices are provided in connection with attended terminals 142, mobile services 144, unattended public kiosk stations 146, somewhat less armored in-house or corporate stations 148, third party services 152, or even a user's general purpose computer 152, equipped with secure web communications and one or both of a scanner and a printer.

The data and associated information and profile field contents are ultimately stored in a virtual safe deposit box 110 where the contents are fixed and kept safe from damage or alteration. Access to the contents that a reviewer or authenticating user requests, are provided insofar as the submitter or subject user has pre-defined corresponding rights to such access. Permissions may relate to a specific reviewer or authenticator, or perhaps by any anonymous reviewer or authenticator that qualifies by virtue of predetermined characteristics such as a predetermined security profile.

This limitation on access and preferably also on the right to take actions such as to enter authentication field data and the like, are controlled by the secure document delivery functions 70, according to rights and permissions determined in part when a document image or fixed content data are obtained via the document capture function 60. An additional but optional transactional function includes the document authentication function 80. These functions are all configured to provide end-to-end security for receiving, encoding and profiling, finding, delivering and authenticating documents and portions of document images and data records that move among users and the virtual safe depository 110.

The secure document delivery and transaction functions preferably manage encryption and security when a document (construed as encoded in a data file or including a data file) is deposited or transferred from a digital on-ramp input device 142 to 154 to be stored. The document (file) is subject to processing according to a secure document transaction performed by the user from their account using an access device or performed by another user according to a procedure that the user/subject or the user/submitter has permitted. Permissions can be on a case by case basis or according to a permission that is provided according to the terms of the terms of subscription of user 22.

Preferably, the applications/GUI process 50 of the system logs transactional audit trail data that is generated every time a document or record is deposited, withdrawn, transferred, viewed or authenticated from a user's account. The transactional audit trail can be used by the document validation and authentication functions to establish integrity, authenticity and thereby to render the document, file or copy thereof substantially non-refutability notwithstanding passing of every document into and out of the virtual safe deposit box memory area associated with the user.

The terminal devices by which users 22 obtain access need not all have document input (scanning) capabilities. In FIG. 3, however, the document capture choices comprise a number of different input devices and/or input environments that are distributed over a wide network, preferably comprising the public Internet. The input environments can be public or within an organization, fixed or mobile, attended or unattended. At attended stations (142, 144, 152), an operator optionally can capture or input data associated with the user and the document capture transaction, examine original documents and note any evidence of damage or alteration, etc. The distributed document capture system 60 processes in-bound documents, files and records which are to be stored and later to pass through the secure document delivery system 70.

Input from unattended stations (146, 148, 154) may rely on unsupervised input and scanning activity from the user alone. Input from a station without biometric measurement capability may rely on a user identification with a lower assurance than a station having such capability. The document capture system can take into account the capability and level of security of the log-on station serving the user 22 when assessing the level of trustworthiness of a transaction (e.g., the identification of the user and the bona fides of any documents or data that are uploaded).

Due to the distributed nature of the document capture system and its plural associated input devices, variations in load level are to be expected. According to one embodiment of the invention, the distributed document capture system can encompass a system load balancing service. This ca be accomplished using an Advanced Telecom Computing Architecture (ATCA) blade server configuration with grid-based cluster processing capabilities. This configuration provides a scalable server arrangement with multiple processors capable of accepting and processing in-bound document capture transactions, including document images or data files and associated information, at high processing loads and/or at a high rate of throughput.

According to an advantageous aspect, documents and information submitted by the user and accepted through the document capture system can be processed through processes that automatically capture information embodied by submitted documents. Examples of automatic information capture include optical character recognition (OCR), intelligent character recognition (ICR), barcode and optical mark recognition (OMR), which is useful for documents and records that contain such coding. It is also possible to detect automatically other aspects of documents, such as exact dimensions, magnetic ink markings, spectrally concealed markings and the like. Each document can be subjected to automatic data capture encoding steps by scanning for the corresponding codes, or alternatively the user 22 is prompted over the applications interface 50 to select whether such codes are to be processed.

The system can be programmed automatically to classifies certain forms of documents and records, or to default to certain classes, based on the format of data recognized. For example, the system can be arranged to discern standard form documents. The system populates database fields with information obtained either directly from the records or from other inputs associated with their submission. The database fields also can contain related processed information, such as a profile defining a security assessment, limitations on the extent to which the documents and records will be revealed to users other than the submitter or subject (if at all), and logging transactions associated with the documents and records.

According to another input scenario, organizations handling plural documents or records can be set up for electronic batch depositing of records, either on demand or on some regular basis (e.g., monthly). Certain organizational records are derived from government entities, educational institutions, testing organizations, and the like. Such entities are inherently trusted to a certain extent, and this trust is associated with the associated documents or records provided that the documents or records are captured directly from the entity and thus have not been exposed to risk of alteration.

Apart from documents that are received from a submitter for reference by a reviewer, the invention can be used to pass organizational records safely to the subject of such records. An example is bank statements that may be uploaded from a financial institution to the virtual safe deposit boxes of subjects who log on as users to access their own information. In another example, a credit card company may electronically submit thousands or millions of credit card statements in the form of digital files that are automatically classified and routed to each individual customer's virtual safe deposit box. Not only does the credit card company save in printing and mailing costs, but the user's information enjoys added trust as well as better confidentiality and protection from fraud and identity theft than may be possible using the mail.

There are substantial additional benefits made possible when documents and/or data files are captured by the system in a manner that specifically directed to their subject as the user. By collecting account statements (monthly or otherwise) by electronic deposit from a contracting entity into a user's virtual safe deposit box, a complete record of such statements is safely and accurately accumulated in one place, accessible confidentially by the user for review. The user has the option to consolidate monthly statements from multiple institutions into a central and secure account or balance sheet. The virtual safe depository aspects of the invention thus have operational efficiencies and security benefits that compare favorably against the complexity and security risk of a person accessing different websites with different procedures and passwords for on-line account statements, or receiving and filing multiple paper copies.

According to another aspect, the distributed document capture aspects of the invention can be configured to receive or to convert all scanned images and/or electronic documents of recognizable format into non-proprietary PDF-A (portable document format: Archive) file format. This format of pdf file is useful for storing and archiving fixed content documents in an unalterable digital format. The pdf format can be stored with metadata representing details of its generation, and protected by available security provisions such as timestamps, digital signature, message digest hash generation and the like.

The virtual safe deposit box of the invention comprises memory 110 that is structured and protected by programming. This aspect is generally termed a Document ATM Safe Deposit Box, reflecting the elements that resemble a bank automatic teller terminal system. The programming and memory are configured according to the invention to provide limited access to secured and protected documents and files. The secure memory aspect of the system is a core component of the secure document transaction network

Having established the authenticity of a captured document, and depending on the document involved, the user or subject may opt for short term, long term or permanent storage. There is little additional overhead or expense associated with each document, after establishing the user account and the various default assumptions or specific procedural steps that the user requires for documents of a given category. Thus it is readily possible for a user to store important personal identification documents, images of documents of value, and the like, together with a lifetime of routine bank statements and copies of invoices.

Associated database fields for captured documents can include submitter and subject information, a log of reviewing parties and dates, the date and circumstances of capture or submission, pertinent descriptive terms (optionally including terms extracted from the content of scanned document or uploaded data files) and similar information facilitating database organization and search. The virtual safe deposit box system provides the user with seamless manageability and access to all documents and records which have been deposited into or for the benefit of their account.

Certain documents may be required to be retained for a certain time for regulatory reasons. Additionally, beyond the required retention time, the user may choose to have documents automatically purged. The document management aspects of the application layer of the invention database can be programmed to a meet or exceed the strictest regulatory standards for long-term preservation and proof of authenticity, and/or to effect the user's options as to document destruction and purging.

According to another embodiment, a redundant or mirror copy 111 of the virtual safe deposit box repository (FIG. 3), with one or more back up server facilities, can be provided for disaster recovery. The main repository and also the disaster recovery mirror, can be scalable to encompass any number of users and documents.

An advantageous aspect of the inventive system is a document authentication facility. Depending on the document and the subscribing users, submitters and reviewers, it is possible in a series of communications to compare redundant copies or to compare information fields to provide an indication of authenticity. In the case of data that is in digital form, optionally encrypted, a document digest key can be generated from a file according to a known hashing algorithm. Without actually communicating the file contents, it is possible to generate and compare a digest hash from a file to be tested for authenticity, against a previous digest hash (perhaps made when the document was submitted) or to a new hash generated from a redundant and remotely protected copy. For documents of particular value or sensitivity, a full panoply of these and other security and confidentiality steps may be appropriately and selectively undertaken.

According to one embodiment of the document authentication and validation elements of the inventive system, a test copy of a document can be re-validated by comparison against a copy safely stored in the system. This process can include a change of format. Thus, for example, a document captured from a bitmap scanning device can be stored in the virtual safe depository as a fixed content pdf with associated and separately stored metadata, encryption, logged access data and/or other parameters that can be consulted to assure authenticity. If a later document is presented and image scanned, or alternatively if a word processor format copy of the same content document is provided, the inventive system can repeat all or part of the document capture steps on the new document to enable comparison of all or part of the resulting captured document to the stored copy, using the same format. Conversely, a temporary copy of the safely stored copy can be processed back into the same form as the submitted content (e.g., back into a word processor file format) in order to make a comparison using two sets of content in the same format. This capability permits a document or record to be quickly validated and authenticated, over a change of content format.

According to another aspect, the system generates and can report a complete authentication audit trail by chronological history and active party (user, etc.) for each protected document or record in the system. The audit trail history preferably includes, among other possible data fields, when document was deposited, by whom it was deposited, the identification parameters from the depositor (submitter), and the transactions that have been performed with the document. Any associated or embedded digital signature and digital watermark applied to the document can be discerned and reported. If authorized by the ultimate owner (subject or submitter), a user can request or a printed version of the document's complete audit trail history.

A simple encoding scheme is preferably provided as an option for selective deployment by the user, subject or submitter for documents of a comparable level of sensitivity. When the scheme is invoked the document authentication process generates and embeds a small barcode seal at the edge of each page in a document or record which is printed or faxed from their account to a third-party. This code can comprise a two dimension barcode carrying an alphanumeric serial number code. By scanning the barcode, a third-party individual or institution can inquire with the inventive system (as a user) to determine associated database information that assists in permitting that individual or institution to validate and authenticate the document.

Preferably, such verification is a two step process. The system matches information contained in the barcode with information stored in the account. Advantageously, the process can involve decryption of the code data based on a password or key algorithm. Assuming that the respective codes match as expected, the system can then present inquiring user (a reviewer) with a digital version of the original document stored in the account. A verification code is generated only after the system has matched the barcode data, or its decrypted analogue, with the stored system data. This permits the reviewing person to confirm that the paper-based document in hand matches the original un-altered digital version.

This process also can work in the opposite direction, namely to permit a user who has in hand a valued original document, to communicate over the system to obtain a copy of a stored document (functioning as a reviewer who will undertake to vouch for the accuracy a stored document). Once a verification code has been issued for the stored document in this case, the associated information is stored and can be imprinted for future reference on any later printed copies, enabling later reviewers to benefit from the collaboration of the vouching reviewer.

Details regarding the authenticity and verification check preferably are stored in the database of entries that relate to the original document in the user's virtual safe deposit box. The details about the identity of the verifier, when verification was performed, the manner in which the verifier established identification, etc., can be stored in a transactional audit trail to enable later reviewers or processes to accept the verification or perhaps to regard the verification with appropriate suspicion. Nevertheless, the verification process can more or less successfully close the loop between the paper-based and electronic document authentication worlds. In a situation where the verification details provide sufficient assurance in view of the risk at stake, the verification is effective as a sort of guarantee that a document or record which has been submitted is an unaltered, valid and authentic duplicate of the original.

The extent of verification according to this process need not be a yes/no guarantee provided by the inventive system. On the contrary, the system is designed with the understanding that there are ranges of risk and benefit that vary with particular circumstances. Documents over a range of value may be submitted, verified and reviewed by entities whose identification likes ranges from questionable to assured, and whose reliance might be anything from trivial to substantial. It is up to the respective users to selectively rely on data in the system or to prudently decline to do so, based on the circumstances, the information available in the system and the risk of loss.

In an advantageous embodiment, the system of the invention is applied to a public data network 30 (such as the Internet), and can accept input from the general public over terminals 154 operated privately under user control as shown in FIG. 3. Alternatively, or in addition, the system can rely on a series of distributed terminals 148, 152 that are operated by organizations who participate in the inventive system. In either case, the system allows subscribers or the general public to deposit, withdraw, receive, transfer, view, authenticate and otherwise manipulate their critical documents and records under the user identification and document validation protections accorded by the invention.

Insofar as terminal equipment is provided that is specific to the document and file capture and management functions of the invention, unattended user operated terminal facilities 146 can be provided that are similar to traditional bank ATMs, and include document scanners. These functions can be built into ATMs or provided into specific terminals made available at financial institutions, retail locations, convenience stores, business products companies, copy and shipping centers, etc. The terminal devices can comprise firmware operated processors coupled to a keypad, a scanner and available identification inputs, such as an automated digital camera or other biometric input. Such terminal devices are relatively secure and can be programmed to decline operations if associated sensors, cabinet operated switches, tilt sensors or other inputs suggest that anything might be amiss. The terminals can have limited input/output functionality and secure socket communications to a remote server, for protection from hacker attack or tampering.

Alternatively, and in a tradeoff of security for convenience, the system can accept data and control inputs from a user permitted to access the system using a home or business terminal with an internet connection and a scanner. FIG. 3 shows several alternatives including attended versus unattended, mobile or fixed services, public or in-house or third-party service operated, and general web-coupled security options. The invention is operable using all or any one or any subset of these alternatives, for document capture and also system control.

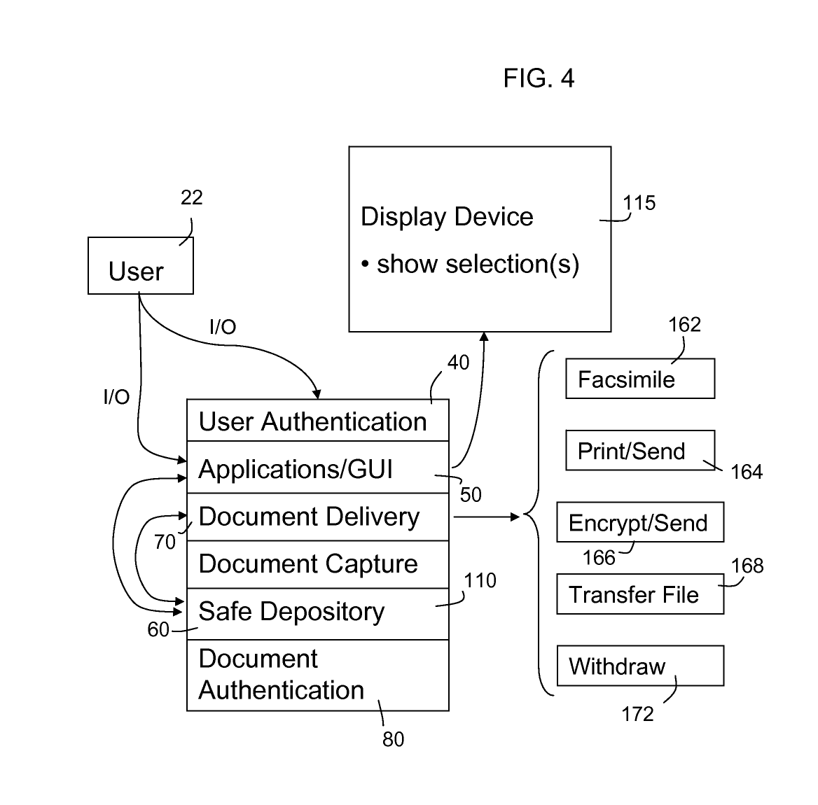

FIG. 4 illustrates details of user control of document delivery using a display device for presenting user selections. A keypad, mouse, control ball or wheel, touch screen or other input can permit selections made by the user in conjunction with a display device 115 on which the selections are offered. A non-limiting set of selections for output can be chosen, comprising facsimile 162, send for printing 164, send encrypted 166, transfer file 168 and withdraw (erase) file 172. These output selections are made as a document delivery function (after user authentication and user selections invoking document delivery from the safe depository 110).

In a captive or in-house alternative, corporations and institutions that have frequent need of access can optionally employ an institutional scanning kiosk 148. The institutional kiosk has most or all of the same capabilities as a public ATM-like terminal, or can be customized in view of the institutional function. For example, the institutional kiosk can be coupled via suitable communications channels to an institutional network system (not shown) from which documents and data are generated as virtual documents in image format. With appropriate programming, this system can make automated deposits of files and documents into users' virtual safe deposit boxes 110, such that the system can operate in a paperless way from both the capture and retrieve/review ends.

Certain user control instructions and functions such as simple viewing of retrieved documents and information, do not require a full kiosk installation including a scanner. By logging into an interactive website interface, preferably using encryption and secure socket layer communications or the like, the user can make appropriate control selections, respond to prompts, and can view information and retrieve images when operating in a reviewer role. For these purposed, the inventive system can be accessed from any desktop, laptop or handheld computer, personal digital assistant or telephone that can be used for submitting control inputs and viewing data output from the inventive system.

According to one embodiment, users are offered as a part of at least one of alternative subscription plans, a secure transaction appliance. The appliance can be preprogrammed with identification codes whereby actions taken via the appliance are associated with the corresponding user's account. The appliance can include a processor that facilitates setting up and activating the associated user account. Thus the user can commence secure document transactions from a desktop or mobile computing device through the appliance, with an added level of security. In a possible embodiment, the appliance can comprise a document scanner.

With somewhat more limited functionality, a mobile telephone or PDA device with communications capabilities can provide a mode of connection to the inventive system at least for entry of control commands and the like.

A mobile document scanning terminal or service is also possible as provided above. The mobile service relies on a van-carried scanner and mobile data link to a remote service. The mobile scanning service is cost effectively outfit with a high throughput scanner and document processing system, and can be contracted to visit a customer site to capture document images and to index documents at an efficient rate. Certain customers whose records are to be made paperless may contract for image capture together with shredding of the original paper copies of documents, e.g., to convert a paper archive to an electronic one. The mobile scanning arrangements can be operated in conjunction with shredding operations for those customers.

In one embodiment that is particularly efficient, the mobile scanning service comprises an autonomous document capture system 144, e.g., carried in a van, which system accumulates data in a local storage device that is coupled intermittently into data communication with a web-accessible service. The upload is accomplished, after completing a customer job or at the end of a day, etc. The upload can be accomplished by wireless communications over telephone or preferably a satellite data link. Alternatively, the data can be uploaded by wire or fiber coupled communication lines that are used only when the local storage device carried in a van or the like happens to be located at a facility having the required data communications facilities and bandwidth for uploading memory in a reasonable time.

Customer documents and records that are captured in this way can be deposited into a customer virtual safe depository 110 as described above with reference to individual customers. The image files can be copied concurrently to un-alterable storage media such as write-once-read-many optical discs in CD, DVD or other digital data format. In one embodiment, a mobile scanning platform arrangement has been specified with the capability of capturing more than 100,000 pages per day (over two million pages per month).

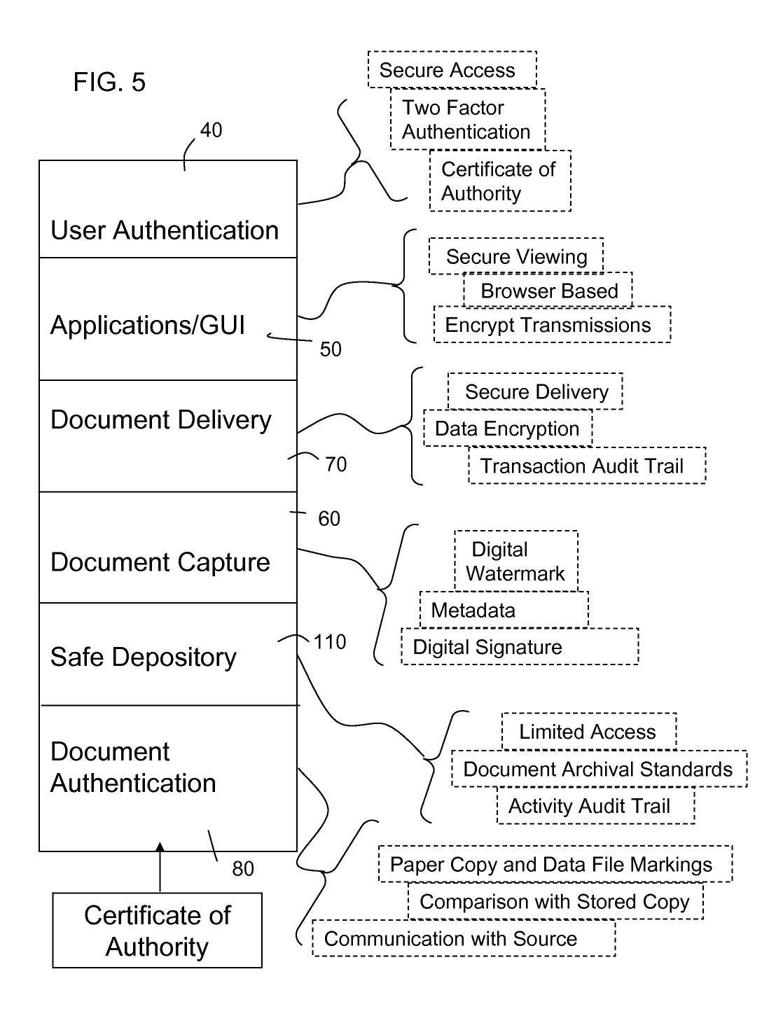

With reference to FIG. 5, there are aspects associated with each of the functional elements 40 to 110 that contribute to the security of user authorization and document control. Although not all of the security aspects are mandatory, each is preferred.

The following discussion, referring to FIGS. 1-4 and 6, describes an exemplary embodiment that is illustrative but should not be regarded as limiting. In this embodiment, the exemplary user 22 is assumed to be an individual. User identification relies on a user card that preferably comprises a smart card 130 that must be presented and engaged in a card reader terminal 132 and provides an encryption key or internally operates an encryption algorithm. The user 22 provides a personal identification number and/or password responsive to a prompt.

The hardware elements of system terminal are shown in FIG. 6. The terminal has a processor 200 with program memory and sufficient random access memory to carry on operations. Input/output devices can include a display screen 202 that in some embodiments comprises a touch screen input device for selections. In other embodiments, a keypad or keyboard 204 is provided for selections and entry of alphanumeric data. Printer 205 is provided for hardcopy document printout, receipts and logs. Document images are captured from a scanner 206. A biometric input device 207 can be included, at least with a camera and optional adapted for imaging a fingerprint or iris image. In embodiments equipped for reading bar-coded authentication indication codes, a barcode scanner 209 can be included.

The processor 200 communicates externally through a data network, preferably the public Internet 30, with a remote document server coupled to the virtual safe depository 110. For limited input and output functions, the processor or the remote document server system can be accessed via the user's PDA 211 or cell phone 212.

The user's account profile and digital certificate and/or a digital signature hash can be embedded inaccessibly in nonvolatile memory carried within the user's smart card 130. The specific algorithms used to program and issue each smart card 130 are proprietary, but are generally of the type known and used in smart card access to data sources such as debit card, payment/authorization, access control and similar systems, including reasonable measures available to prevent them from being hacked, intercepted or duplicated.

The user inserts their user smart card 130 to enable a digital on-ramp input device or access device of one description or another as discussed with respect to FIG. 3. The user is prompted to enter a four digit PIN, in a manner similar to the process of logging into a conventional ATM machine of a banking system. The system then goes though certain steps to establish the user's identity. In a VERIFY step, the system accesses and/or invokes the smart card processor to access account information and the user's digital certificate profile which is stored on tine smart card's embedded microprocessor. In a VALIDATE step, the information stored on the user's smart card is tested using secure communications against expectations based on the user's profile and account information, stored within the User Authentication System. A further CERTIFICATE OF AUTHORITY step produces an output that should match information contained in the user's smart card. These steps involve encryption and/or hash functions that will not work unless the user-entered PIN, and the account information on file all match when processed using the digital certificate that is known to have been originally issued to that individual user. Any equivocal results result in an error message and if not corrected (for example within a limited number of tries), the user and user card are blocked from access until the problem can be investigated.

The terminal device comprises a user display 115 or 202 on which information and prompts are offered to the user, including status information signaling the successful user when access to their account has been granted. In the event of failure of access, security and diagnostic steps are possible, including recording an image of the user, collecting biometric information, prompting for additional information, etc. However access is not permitted unless security steps are smoothly passed. The terminal device has at least the user display 115 for display output, but also preferably has additional output capabilities including printer 205 for hard copies.

Provided the user 22 is granted access, a main transactional menu is presented to offer the user a selection of actions, normally a selection of secure document transactions available to that user. Different selections might be granted to different users based on their subscription, security status and other factors.

Assuming a full function terminal is used, for example, the user may be offered selections comprising:

DEPOSIT wherein scanning a paper-document or record into the system via image scanner 206 or uploading a digital document via a portable storage device PDA or other source can be permitted. In conjunction with this operation, certain options can be offered, such as scanning and processing options for the document they wish to scan, e.g., whether to scan at a default or other resolution, whether to scan in color or black & white, etc.

The user 22 may have established data subdivisions such as separate digital filing cabinets or folders in their account, to better organize documents into categories. The user can be offered an option to select one of these specific destinations to receive the deposit. Additionally, the user can enter descriptive and identifying data that may be relevant or unique to the individual document, such as document title, summary, nominal date, description, parties, or any other key pieces of information. The information entered is cross referenced to the document and preferably is electronically embedded or tagged to the document upon depositing the document into the user account. This information thereafter can be searched for allowing the user to search and easily find and retrieve any document in the account or in a searched subdivision of the account. The searching capability reduces the need to subdivide documents fastidiously into folders, allowing a document to be found relatively quickly even though the account may grow to contain many documents.

The user loads the associated document into the scanner 206 coupled to the terminal and selects a SCAN function. The document is scanned and digitized. The image is displayed on the associated display device 115 or 202. If adjustments are needed (e.g., size, cropping, brightness and contrast), such adjustments can be enabled and a re-scan can be accomplished if needed. The user views the displayed electronic version, verifies that the image quality, index data, folder and or cabinet destination are correct, and selects DEPOSIT. This adds the document or records to the user's virtual safe deposit box.

During the deposit process, additional pieces of information can be inserted automatically. These preferably include the time, date, scan location, account number or any other key piece of information which is generated during the transaction process, and are inserted as metadata together with the document or file data. The system applies a Digital Signature code. In the case of a document image, the image data can also be invisibly marked by applying a digital watermark seal, namely a steganographic alteration that is discernable by an algorithm programmed to find it, but otherwise is substantially undetectable. The system embeds and tags each individual document or record with this information to provide evidence of its source and authenticity as stored in the user's account.

The terminal device can be programmed to encrypt the document content, index data, metadata and Digital Watermark along with the user's Digital Signature and to upload the encrypted data as a unit. This can involve communicating the data through a secure communication link or sending an already-encrypted data file through either a secure or open communication link. The data then resides safely in the virtual safe deposit box 110, awaiting transactions in which the data might be accessed for one purpose or another. A confirmation is issued upon the system successfully depositing the document into the user's account. The confirmation is displayed to the user via the Display Device 115/202. The document printer 205 optionally is used to print a confirmation receipt. An email confirmation is also possible to a separately identified optional user email address.

The digital signature that is associated with the user and automatically applied to documents and records upon depositing them into the Document ATM System preferably is a proprietary matter as opposed to application of a conventional digital signature of the type used commonly to electronically memorialize a letter or contract. In particular, according to the invention, the digital signature does not function as a signature to establish a legally binding offer or acceptance. Instead, the digital signature is uses to provide all or part of an encryption hash that is uniquely associated with the user.

Having previously placed a document into the account, the user has the option via the user interface to select to WITHDRAW a copy of any document from the account for example to print a copy or to download a copy of the file or a copy of the document image to an access device such as a portable storage device (e.g., flash memory), a PDA or another device that the user may have and for which facilities are provided for connecting to the terminal device. The user has the option via the user interface to DELETE a document or record from their account, thereby removing the data and its associated indexing and other information from the virtual safe deposit box, with or without printing the document locally. This process can involve double prompt (“are you sure”) exchanges. The deletion also applies to all copies maintained in any of one or more data mirror depositories 111 (FIG. 3). The deletion preferable includes wiping or overwriting the file storage sectors on the storage device as opposed to simply marking a file allocation table to release the associated sectors for later use.

Another optional function is to TRANSFER a copy of any document or record in a user's account, namely to provide secure access to the document or record to any third-party recipient through the secure document delivery system of the invention (FIG. 4). This process may involve one or more of the selectable methods including those shown as examples in FIG. 4. A secure fax delivery function 162 sends an image of the document to a fax number that is of record for that party or is provided by the user. Confirmation of the fax transmission is automatically logged into a transactional audit trail log. The transactional audit trail data appends the metadata, index data and the like that becomes permanently associated with and tagged to each document in the user's account. Secure email delivery 166 can be used to electronically encrypt and deliver a document to a third-party recipient by selecting a file encryption technique. It is also possible to send by unencrypted email or other communication 164 an attachment such as a pdf file or a document image bitmap or compressed image file fit to be printed without substantial decoding. Confirmation of the secure e-mail delivery or other response automatically logged into the Transactional Audit Trail. Preferably, another transfer option offer to the user is to transfer (168) a document image or file to another user who can log in to obtain access. Transfer to users can invoke transfer to a print fulfillment service center such as FedEx Kinkos or a comparable operation that can receive, print and provide the copy to a transfer addressee, by courier service or as otherwise dictated. Transfers can also be directed to institutional users with whom the user has some contractual arrangement or obligation.

The system of the invention can employ conventional user personal computers, scanners and the like for capturing documents and data files. However if the capture is accomplished through a dedicated Digital On-Ramp terminal device, there is less uncertainty involved and the transaction can be regarded as relatively more trusted. The nature of the capture terminal can be provided in the data that is collected and indexed against each captured document or file. The documents images and data captured via a trusted Digital On-Ramp device are transmitted into the system via secure communications over the Internet. Optionally, documents and images from conventional PCs and scanners are accepted using secure SSL encrypted communications, of the type now used for many transaction such as sales involving credit card payments. The in-bound documents and records that have been captured are passed through the ATCA blade load balancing system as described above, which manages and distributes server loads on a scalable processor array forming a document processing system. In one embodiment, the in-bound documents including each scanned image and associated data are processed through a grid-based cluster processing configuration. The processor(s) process the information and data, carrying out a pre-defined set of system rules as well as user selected options.

After completing successful processing of an in-bound document, the distributed document/data capture system classifies each document or record and stores the document image in a PDF-A file format file, at a memory location associated with the user, i.e., a corresponding virtual safe deposit box. Indexing and descriptive information is entered into a database for various uses including searching, reports and statistics, billing, etc. A deposit transaction confirmation is sent to the user and logged into the system. No further processing is required unless and until a user seeks access to the document, which user is the original submitter or a reviewer who has been accorded rights to access the document or record, by the submitter (e.g., in a TRANSFER transaction, or by the subject of the document that the submitter has identified) or by operation of the system. In that case, the user who seeks authorization must pass certain identification and authentication tests.

The authentication of the documents themselves is a further aspect of the invention. The system preferably employs a comprehensive set of principles and technologies to prevent unauthorized access, to contribute to identity theft protection and to enable documents that are deposited to beauthenticated as well as withdrawn, transferred or viewed by the submitter, subject or other authorized user.

Preferably, all captured documents are received, stored and accessed according to a consistently high level of security, authentication and system integrity. This provides a measure of respect that encourages users to employ the system as submitters and subjects, and allows reviewers to rely with a certain level of confidence on the documents and data provided by the system. On the other hand, it is also possible to provide for varying levels of security. For example, the system can be used to accept submissions from users whose identification may be incomplete or documents and data that may be suspicious for one reason or another (e.g., documents that may have failed an authentication attempt). Nevertheless, by providing database fields by which a user may delve into the background of a document or its submitter, the user (acting as a reviewer) has the ability to determine independently whether to rely on the document or not. From another perspective, the prospective submitter of a valuable and confidential document also is provided with a choice and a set of selections enabling the submitter or subject to limit the disclosure of information that may be sensitive, such as account numbers and the like that might be misused by an identity thief. These features make the system useful as a source of information to back commercial transactions and the like of high value and high risk, where very substantial diligence may be due, or transactions of modest value and low risk, where the reviewer may be willing to accept the representations of a submitter of dubious credentials. The system is useful as a clearinghouse containing all such documents and data and supporting various transactions.

According to one aspect of the invention, the captured, indexed, authenticated and digitally marked documents and data are stored in the virtual safe deposit box in a manner that is well documented and verifiable. Thus the stored copy has become nearly as trustworthy as an original document. If an original is lost or destroyed, the stored copy can beauthenticated by examining the history of its submitter, circumstances of capture, authentication, etc. The stored copy therefore has a value that comparable to the value of the original. In order to protect the now-valuable documented copies, the document storage arrangements include a disaster recovery infrastructure intended to provide long-term integrity and trust in the authenticity of each stored document and its associated data.

The PDF documents and records are stored in a memory that is configured for fixed content data. Provisions can be established in software to prevent unauthorized alterations, and at least a reference image of the captured document can be stored in a medium that is inherently unalterable. (As stated above, access logging information associated with documents must be updated and thus needs to be capable of being appended.) The data is preferably content addressable at least by searching profiles keywords assigned to images, and preferably with the option for content based searching, which normally requires that image documents be OCR processed.

The documents stored in PDF format are preferably backed-up regularly to a reference archive system (GO). This back up processing preferably includes storing the document image, associated index values, metadata, the digital signature profile, content address and other relevant information about the document. The back up can be to one or plural separately maintained preferably geographically distant mirror data storage facility, or to a read-only media archive. In the event of removable media, a copy can be provided to the submitter or subject. Copies an be made on microfilm, or even printed media. In the case of mirrored data storage, the process of mirroring can involve ongoing communications over a secure Internet connection or dedicated data transmission channel.

The Application Layer System advantageously in based on a service oriented architecture (SOA) framework (83). For that purpose, distinct processes are available in a manner resembling subroutines that can be invoked when useful to any of the various subsystems that effect system operations. This type of architecture provides a consistent and smooth workflow even as a great deal of system activity is underway. During nominal operations, numerous documents and records are being deposited, withdrawn, transferred, viewed and authenticated through the system simultaneously to serve multiple concurrently active users.

The Application Layer comprises tiers connected in a service oriented architecture framework. A presentation tier can be provided, e.g., employing the Adobe/Macromedia Flash platform. As one advantage, the Flash-based graphical user interface provides a standardized environment which can interact with a variety of devices and operating systems that may be employed with user terminal devices. The standard web-based GUI operate through any one of various available Internet browser programs, capable of supporting 128-bit SSL encryption.

A further tier leverages the J2SE/J2EE Platform. This tier is responsible for processing and performing transactional command requests generated by either the user interacting with the GUI or from programmed processor outputs that are performing system functions and responding to the user's requests. Operations in this tier can comprises data transfers in Business Process Execution Language (BPEL/XML) format for versatility and consistent operation of respective programmed functions.

According to one aspect, the GUI enables presentation of user's requested documents for viewing in a Macromedia 63 Flash paper format. This operation permits viewing of documents without downloading the original PDF data that remains stored in the virtual safe depository memory. Rendering of document images to the web browser, without downloading the original PDF, involves a relatively small file transfer to support fast viewing, compared to downloading and locally processing the original PDF. Security is served because the system is not required to transmit the original PDF to display an image.

Most or all of the functions permitted by a user via a private PC can be provided using public access terminals or kiosks. Members of the public can use such kiosks to deposit, withdraw, transfer, view or authenticate any document and record of their account, or as permitted or requested to service transferred documents or records of other users' accounts, using a public access terminal or kiosk. The kiosk terminal can be customized for public access using particularly wear tolerant durable input and display devices. The kiosk can have an integrated touch screen interface for accepting user input responsive to prompts, a key pad for numeric or alphanumeric data entry, an electronic signature pad for identification input, etc.

When a user logs into the kiosk and satisfies identification protocols, the user may select to deposit a document or record into their account. The user is prompted by the system to insert the document into a feed tray associated with an embedded document scanner. The kiosk can comprise a scan server appliance with a mechanical feeder that moves the document (or a movable carriage carrying the document) over an internal scanner head to scan a pixel image. Associated software routines accomplish image processing operations such as discerning the size and orientation, auto image rotation, cropping if desired, setting brightness and contrast levels for optimal presentation of text or graphics, etc. The scan server appliance can employ an available scanner software package such at the Image Core application, which performs image processing operations such as image enhancement, de-skew, cropping and auto rotation, etc. These steps can include interaction and options selection by the user, wherein the scanned images are presented to the user for viewing via the touch screen interface and options are presented intending to optimize the process. This same input/output configuration including the touch screen can be used at least for offering optional choices to the user and accepting the user's choices.

After a document is duly encoded and transmitted over the network to secure document storage, and after a deposit verification is transmitted back to the user at the kiosk (or other terminal), the programming automatically deletes all locally stored information and imaging data. This prevents a subsequent user of the public kiosk terminal from viewing private information, for example if the earlier user fails to log off after depositing the document. The kiosk can also time out after a brief interval of inactivity for protection of confidentiality for users who fail to proceed with a transaction after beginning.

In addition to the foregoing aspects, which are apt for public terminal use, the public kiosk preferably employs aspects that expand its functionality and usefulness, particular to novice users. These can include a software based or preferably a live help system that automatically connects the user to a customer service representative, a digital video camera, a touch screen display (as described), a microphone and speakers and a secure internet connection. The integrated system can include remote access or remote monitoring provisions that facilitate delivery of assistance by the representative. For data access in particular situations, the kiosk can be equipped for wireless network communications or wireless communications with Bluetooth or WiFi user devices.

The kiosk variety of user terminal preferably can print transactional receipts as well as complete copies of any document or record from the user's account or transferred to the user, for example via an included Laser Printer. An integrated barcode reader can capture data on a paper document previously generated from the system with an applied code as discussed above. Alternatively, reading the barcode on such a document can be accomplished using an image analysis routine in the document scanner. (That is, the scanner data processing steps can include discerning and capturing barcode data of on a document when scanned by the document imaging scanner, and associating the document with previously captured content).

The kiosk generally comprises a programmed computer processor coupled for communication with the data network and having a set of peripheral devices including the display, key or touch screen inputs, scanner, camera, printer, etc. See FIG. 6. Unlike a typical desktop or computer system wherein peripherals are wired to a computer processor box, in the kiosk arrangement these peripherals are contained in an embedded fashion where the input and output devices are internally arranged in a self contained cabinet arrangement such that the devices are exposed only insofar as needed for operations.

According to another embodiment, a corporate form of user access kiosk is also possible. Corporate or enterprise kiosks can have the same functions as a public kiosk or can be configured for a limited set of functions needed to serve the needs of the corporation or enterprise. The corporate kiosks can be distributed throughout an enterprise, government agency or the like and are useful to provide high throughput services for high volume scanning and other services. The corporate kiosks can be configured to be capable of the same services as public kiosks, but are more aptly used for high volume activities related to the corporation's operations. Also, a corporate environment is generally safer than a public one due to the protected location of the kiosk on corporate premises and the greater care taken by users. Thus, the corporate kiosk can be configured and built in a less armored and more user-friendly manner, for example including a mouse or pointing device, having potentially exposed wires, etc.

Preferably, however, the corporate type kiosk employs a robust level of security respecting user identifications and authentication. An authorized user is provided a smartcard user card and is required to enter a correct 4-digit PIN Code to pass the log-in screen and obtain access to a user account. The arrangements for interfacing with a corporate kiosk can include testing and granting access to an enterprise account, for example using cross references to an LDAP directory. Access by particular users to different levels of enterprise records and authority to review or transfer different categories of records can be distinctly associated with the user identification and made different for different employees.

The foregoing arrangements allow a user to act as the submitter of documents, effecting the necessary log-in identification, image capture and associated data encoding. The arrangements also permit the user to act as a reviewer or authenticator respecting documents or records that may be transferred from a remote user's account or submitted by a third party for review and validation by the user as the subject of the document. If the user chooses to authenticate or validate the document according to an arranged procedure, a validation code or seal can be placed on a printed copy produced by the printer or an associated document imprinter that stamps the paper based document or record with a verification code that contains or is cross referenced in memory to the time, date, an indicia associated with the verifier's user identification and other information useful for future reference.

Identification can be facilitated by biometric identification information inputs and associated programmed processes and data storage by which biometric particulars of users (e.g., thumb or fingerprints, picture image, iris scan, retina scan, etc.) can be recorded for each user identification and used at a later point to test whether the same biometric results are obtained from an unknown person attempting to log in under the user's identification (potentially making unauthorized use of a user card and PIN or password). The biometric measurement information can be stored in memory and indexed to the user's identity or carried by the user's smartcard user card. Preferably, a high level of security and a high threshold of identification are required for access to the user's virtual safe deposit box data. However it is also possible for users to opt for higher or lower security levels, as appropriate for the operations (and risks) that the user intends.

The invention has been disclosed and discussed in detail with respect to certain examples, alternatives and preferred embodiments. The invention is not limited to the embodiments that are mentioned as illustrative examples. Reference should be made to the appended claims, and not to the discussion of examples, to assess the scope of the invention in which exclusive rights are claimed.

What is claimed is:

1. A method for providing for protection of data integrity, comprising the steps of:
supporting data access to a network by users comprising submitters of data content and retrievers of data content;
determining an identity of each of the users that obtains access to the network for submission and retrieval of said data content;
accepting input from said submitter including at least one of a document representing at least part of the data content, and a data file representing at least part of the data content;
storing the data content as indexed to the input from the submitter, and protecting the data content from alteration;
accepting input from a retriever including designation of at least a subset of the data content that is requested for retrieval;
determining according to programmed criteria based on the input from the submitter and the input from the retriever, whether retrieval shall be permitted by the retriever of the data for the subset of the data content that is requested; and,
providing output data to the retriever as a result of said determining.

2. The method of claim 1, wherein the network comprises a public packet data network, and the data access to the network comprises at least one of data encryption, password authorization, and addressed messaging exchange for providing a level of protection against unauthorized reception of the data content over the network.

3. The method of claim 1, wherein said determining of the identity of the user comprises at least one of subscription and password steps, determination of user identity by comparison of prompted answers to a data store, collection of biometric information regarding the user, and communication of user information to a remote data store cross referencing user information to user identities.

4. The method of claim 1, wherein accepting the input from the submitter comprises scanning and digitizing an image of a document into an image data file forming at least part of the data content that is stored.

5. The method of claim 4, wherein the input accepted from the submitter comprises information at least categorizing the document as to at least one of a document description, a category of type of document, an involved entity, an involved property, and an organization that may vouch for the document.

6. The method of claim 5, wherein the input accepted from the submitter further comprises information defining limitations on entities that shall be permitted to retrieve one of the image of the document and the information contained in the input accepted from the submitter.

7. The method of claim 4, wherein the document category is chosen from the group consisting of: documents representing identity, birth certificates, passports, marriage certificates, military discharge records, social security cards, picture ID cards, fingerprint records, membership cards, serial numbers, member numbers, evidence of qualifications, evidence of permissions, diplomas, educational transcripts, professional licenses, operator licenses, sporting licenses, documents associated with value in accounts, negotiable documents, stock shares, bonds, credit and debit cards and numbers, account cards, credit reports and financial statements.

8. The method of claim 4, further comprising accepting from the submitter data content provided and described in sole discretion of the submitter.

9. The method of claim 8, wherein the programmed criteria for determining whether the retrieval of the subset of data by the retriever comprising communicating to the submitter data based at least in part on the input accepted from the retriever, and wherein the submitter has discretion whether to permit said retrieval.

10. The method of claim 8, wherein the programmed criteria for determining whether the retrieval of the subset of data by the retriever comprises comparing at least part of the input accepted from the retriever to security criteria identified by the submitter for application to retrievers seeking access.

11. The method of claim 8, wherein the input accepted from the submitter can specify that the data file shall be retrievable only according to a predetermined security protocol.

12. The method of claim 8, wherein the input accepted from the submitter can specify that the data file shall be retrievable only by the same submitter, acting as the retriever, and further comprising effecting security steps to assure that the submitter and the retriever are the same.

13. The method of claim 4, further comprising generating an encryption hash from the image data file and separately storing the encryption hash for reference.

14. The method of claim 4, further comprising steganographically altering the image file to provide a difficult to detect marker associated with the data content as stored.

15. The method of claim 1, wherein the network comprises a publicly accessible packet data network and wherein the publicly accessible packet data network is used for carrying at least one of the data content and the inputs from the submitter and the retriever.

16. The method of claim 1, further comprising communicating at least part of one of the data content, the input from the submitter and the input from the retriever to a third party for assessment of a measure of trust accorded to at least one of the data content, an identification of the submitter and an identification of the retriever.
